(19) United States
(12) Patent Application Publication
(10) Pub. No.: US 2026/0358460 A1
(43) Pub. Date: Nov. 12, 2026

(54) POSITIONING SYSTEM AND POSITIONING METHOD

(71) Applicant: Sony Interactive Entertainment Inc., Tokyo (JP)

(72) Inventors: Hirotomo YUNOKI, Chiba (JP); Kazuhiro Kono, Tokyo (JP)

(73) Assignee: Sony Interactive Entertainment Inc., Tokyo (JP)

(21) Appl. No.: 19/131,932

(22) PCT Filed: Dec. 14, 2022
(86) PCT No.: PCT/JP2022/046008

§ 371 Date: May 21, 2025

(51) Int. Cl. G01S 5/02; H04W 64/00

(52) U.S. Cl. CPC G01S 5/0284; H04W 64/003

(57) ABSTRACT

The positioning accuracy of an apparatus is enhanced through inter-apparatus communication. A positioning apparatus determines the relative travel distance of an apparatus to be positioned with respect to an auxiliary apparatus by using acceleration data from sensors on both devices. It then calculates a second relative position of the apparatus to be positioned, based on the auxiliary apparatus's position (determined via communication) and the relative travel distance. The positioning apparatus ultimately determines the apparatus's relative position by combining a first relative position calculated from direct communication with the apparatus to be positioned-and the second relative position, which incorporates data from the auxiliary apparatus. This dual-source, communication-based approach improves overall positioning precision.

### TECHNICAL FIELD

The present disclosure relates to a positioning system and a positioning method.

### BACKGROUND ART

PTL 1 cited below describes how the position of a head-mounted display is detected by use of an acceleration sensor and other means mounted thereon.

### CITATION LIST

### Patent Literature

[PTL 1] Japanese Patent Laid-open No. 2022-111143

### SUMMARY

### Technical Problem

For example, on the basis of wireless communication between two apparatuses separated from each other, it is possible to calculate the relative position of one of the two apparatuses with respect to the other apparatus. However, the positions of the apparatuses spaced from each other, when calculated on the basis of the communication between the apparatuses, may differ from the actual positions because signals exchanged between the two apparatuses may be reflected by a wall surface, a floor surface, or a ceiling surface in a room before reaching their destinations or because such signals may be affected by noise and the like, for example.

In this respect, the position of the apparatus of interest may conceivably be corrected on the basis of outputs from the acceleration sensor and other means on board the apparatuses, for example. However, there is a possibility that the position of the apparatus may not be corrected sufficiently solely by the outputs from the sensors on board the apparatuses.

It is therefore an object of the present disclosure to provide a positioning system that improves the accuracy of positioning an apparatus on the basis of inter-apparatus communication.

### Solution to Problem

According to the present disclosure, there is provided a positioning system including at least one processor. The at least one processor calculates, on the basis of wireless communication between a positioning apparatus and an apparatus to be positioned separated from the positioning apparatus, a first relative position as a relative position of the apparatus to be positioned with respect to the positioning apparatus. The at least one processor calculates, wireless communication between the positioning apparatus and an auxiliary apparatus separated from the positioning apparatus and from the apparatus to be positioned, a relative position of the auxiliary apparatus with respect to the positioning apparatus. The at least one processor calculates a relative travel distance of the apparatus to be positioned with respect to the auxiliary apparatus on the basis of an acceleration rate output from a first acceleration sensor included in the apparatus to be positioned and an acceleration rate output from a second acceleration sensor included in the auxiliary apparatus. The at least one processor calculates a relative position of the apparatus to be positioned with respect to the auxiliary apparatus on the basis of the first relative position, the calculated relative position of the auxiliary apparatus with respect to the positioning apparatus, and the relative travel distance. The at least one processor calculates a second relative position as a relative position of the apparatus to be positioned with respect to the positioning apparatus on the basis of the calculated relative position of the auxiliary apparatus with respect to the positioning apparatus and the calculated relative position of the apparatus to be positioned with respect to the auxiliary apparatus. The at least one processor calculates a relative position of the apparatus to be positioned with respect to the positioning apparatus on the basis of the first relative position and the second relative position. This makes it possible to improve the accuracy of positioning the apparatus to be positioned on the basis of the inter-apparatus communication.

According to the present disclosure, there is also provided a positioning method including calculating, on the basis of wireless communication between a positioning apparatus and an apparatus to be positioned separated from the positioning apparatus, a first relative position as a relative position of the apparatus to be positioned with respect to the positioning apparatus, calculating, on the basis of wireless communication between the positioning apparatus and an auxiliary apparatus separated from the positioning apparatus and from the apparatus to be positioned, a relative position of the auxiliary apparatus with respect to the positioning apparatus, calculating a relative travel distance of the apparatus to be positioned with respect to the auxiliary apparatus on the basis of an acceleration rate output from a first acceleration sensor included in the apparatus to be positioned and an acceleration rate output from a second acceleration sensor included in the auxiliary apparatus, calculating a relative position of the apparatus to be positioned with respect to the auxiliary apparatus on the basis of the first relative position, the calculated relative position of the auxiliary apparatus with respect to the positioning apparatus, and the relative travel distance, calculating a second relative position as a relative position of the apparatus to be positioned with respect to the positioning apparatus on the basis of the calculated relative position of the auxiliary apparatus with respect to the positioning apparatus and the calculated relative position of the apparatus to be positioned with respect to the auxiliary apparatus, and calculating a relative position of the apparatus to be positioned with respect to the positioning apparatus on the basis of the first relative position and the second relative position. This makes it possible to improve the accuracy of positioning the apparatus to be positioned on the basis of the inter-apparatus communication.

### BRIEF DESCRIPTION OF DRAWINGS

FIG. 1 is a diagram depicting a positioning system as one example of embodying the present disclosure.

FIG. 2 is a diagram indicating exemplary hardware configurations of various apparatuses.

FIG. 3 is a functional block diagram indicating exemplary functions implemented by the positioning system.

FIG. 4 is a diagram depicting exemplary positions of a positioning apparatus, an apparatus to be positioned, and an auxiliary apparatus in planar view.

FIG. 5 is a diagram indicating an exemplary method of calculating the distance between two apparatuses.

FIG. 6A is a diagram indicating an exemplary method of calculating the distance and angle between two apparatuses.

FIG. 6B is a diagram indicating another exemplary method of calculating the distance and the angle between two apparatuses.

FIG. 7 is a flowchart indicating an exemplary flow of a positioning process performed by the positioning system.

### DESCRIPTION OF EMBODIMENT

### 1. System Configuration

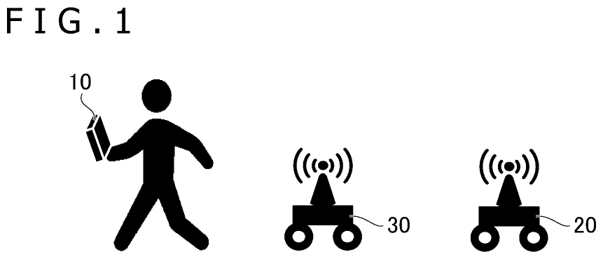

A preferred embodiment of the present disclosure is described below with reference to the accompanying drawings. FIG. 1 is a diagram depicting a positioning system 1 as one example of embodying the present disclosure. As indicated in FIG. 1, the positioning system 1 includes a positioning apparatus 10, an apparatus 20 to be positioned, and an auxiliary apparatus 30, the apparatuses 20 and 30 being separated from the positioning apparatus 10. The positioning apparatus 10 is an information processing apparatus that executes applications such as games, for example. The positioning apparatus 10 may be a mobile terminal held by a user 2. The apparatus 20 to be positioned and the auxiliary apparatus 30 may each be a moving apparatus such as a robot following behind the user 2, for example. By means of an included antenna, to be discussed later, the positioning apparatus 10 can wirelessly communicate with the apparatus 20 to be positioned and with the auxiliary apparatus 30.

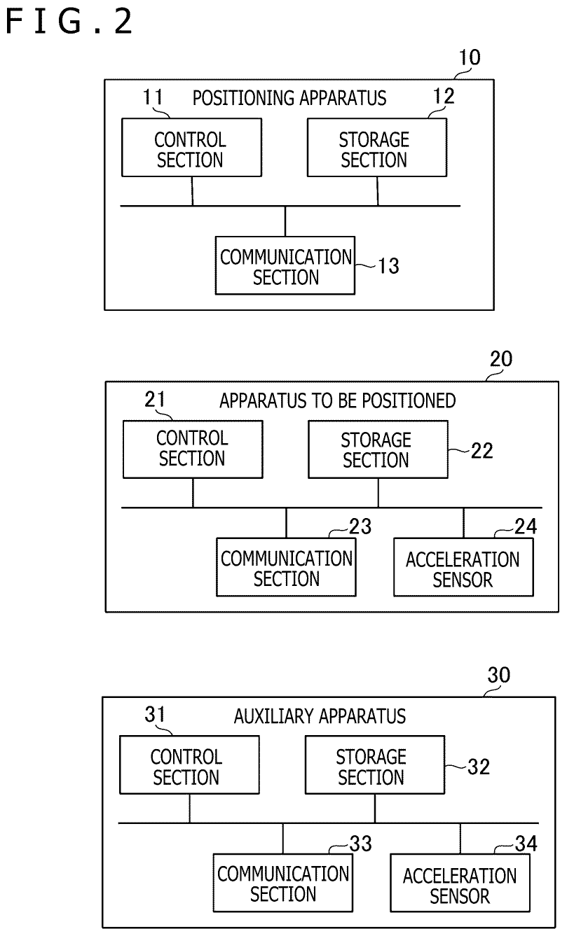

As will be discussed later, the positioning system 1 calculates a first relative position as the relative position of the apparatus 20 to be positioned with respect to the positioning apparatus 10 on the basis of the communication between the positioning apparatus 10 and the apparatus 20 to be positioned. Also, the positioning system 1 calculates the relative position of the auxiliary apparatus 30 with respect to the positioning apparatus 10 on the basis of the communication between the positioning apparatus 10 and the auxiliary apparatus 30. The positioning system 1 further calculates a second relative position as the relative position of the apparatus 20 to be positioned with respect to the positioning apparatus 10 by calculating the relative position of the apparatus 20 to be positioned with respect to the auxiliary apparatus 30 on the basis of acceleration rates, for example, output from acceleration sensors 24 and 34 (see FIG. 2) on board the auxiliary apparatus 30. The positioning system 1 then calculates an ultimate relative position of the apparatus 20 to be positioned with respect to the positioning apparatus 10 on the basis of the first relative position and the second relative position. In this manner, the positioning system 1 calculates the relative position of the apparatus 20 to be positioned on the basis of not only the output from the acceleration sensor 24 of the apparatus 20 to be positioned but also the output from the acceleration sensor 34 of the auxiliary apparatus 30. This makes it possible to improve the accuracy of positioning the apparatus 20 to be positioned on the basis of the inter-apparatus communication.

### 2. Hardware Configuration

FIG. 2 is a diagram indicating exemplary hardware configurations of various apparatuses included in the positioning system 1. For example, the positioning apparatus 10 may be a mobile terminal such as a smartphone or a head-mounted display worn by the user 2 on the head. The positioning apparatus 10 may alternatively be set up in a fixed manner at a predetermined location. In this case, the positioning apparatus 10 may be a computer such as a game machine, a video reproduction apparatus, a personal computer, or a server apparatus. As depicted in FIG. 2, the positioning apparatus 10 includes a control section 11, a storage section 12, and a communication section 13, for example.

In the positioning apparatus 10, the control section 11 is a program-controlled processor (control device) such as a CPU (Central Processing Unit) that operates in accordance with programs such as firmware stored in the storage section 12. The storage section 12 is a storage element such as a ROM (Read Only Memory) or a RAM (Random Access Memory), or an auxiliary storage apparatus such as an SSD (Solid State Drive) or an HDD (Hard Disk Drive). The communication section 13 is a communication device such as a network board, for example. In addition to the above devices, the positioning apparatus 10 may include a display control section transmitting video signals to a display device to display various images on the display device. The positioning apparatus 10 may further include an optical disk drive that reads optical disks, a video output terminal such as an HDMI (High Definition Multimedia Interface) (registered trademark), a data input/output terminal such as a USB (Universal Serial Bus), and an audio input/output terminal such as a microphone jack, a speaker jack, and an earphone jack.

The apparatus 20 to be positioned and the auxiliary apparatus 30 may each be a robot or a small-sized computer such as a microcomputer attached to a robot, for example. As depicted in FIG. 2, the apparatus 20 to be positioned includes a control section 21 acting as a processor, a storage section 22 as a storage apparatus, and a communication section 23 as a communication device. Also, the auxiliary apparatus 30 includes a control section 31 as a processor, a storage section 32 as a storage apparatus, and a communication section 33 as a communication device. The control section 21 of the apparatus 20 to be positioned operates in accordance with programs such as firmware stored in the storage section 22. Likewise, the control section 31 of the auxiliary apparatus 30 operates in accordance with programs such as firmware stored in the storage section 32. Further, the communication section 23 of the apparatus 20 to be positioned can wirelessly communicate with the communication section 13 of the positioning apparatus 10 by means of an included antenna, to be discussed later. Similarly, the communication section 33 of the auxiliary apparatus 30 can wirelessly communicate with the communication section 13 of the positioning apparatus 10 via an included antenna, to be discussed later.

Also, as depicted in FIG. 2, as depicted in FIG. 2 to be discussed later, the apparatus 20 to be positioned includes the acceleration sensor 24 (first acceleration sensor) that detects an acceleration rate of the apparatus 20 to be positioned. The auxiliary apparatus 30 includes the acceleration sensor 34 (second acceleration sensor) that detects an acceleration rate of the auxiliary apparatus 30. The acceleration sensors 24 and 34 included in the apparatus 20 to be positioned and the auxiliary apparatus 30 may each be a sensor included in an IMU (Inertial Measurement Unit) that detects angular velocity and apparatus inclination, for example. When the acceleration sensors 24 and 34 are each included in the IMU, the acceleration rate and gravitational acceleration stemming from the inclination of the apparatus detected by the IMU can be removed from the acceleration rate detected by the IMU. This makes it possible to acquire solely the acceleration rate resulting from the movement of the apparatus. In addition to the above sensors, the apparatus 20 to be positioned and the auxiliary apparatus 30 may each include a magnetic sensor detecting geomagnetism, an atmospheric pressure sensor detecting the atmospheric pressor, a temperature sensor detecting the temperature, and the like.

### 3. Functional Blocks

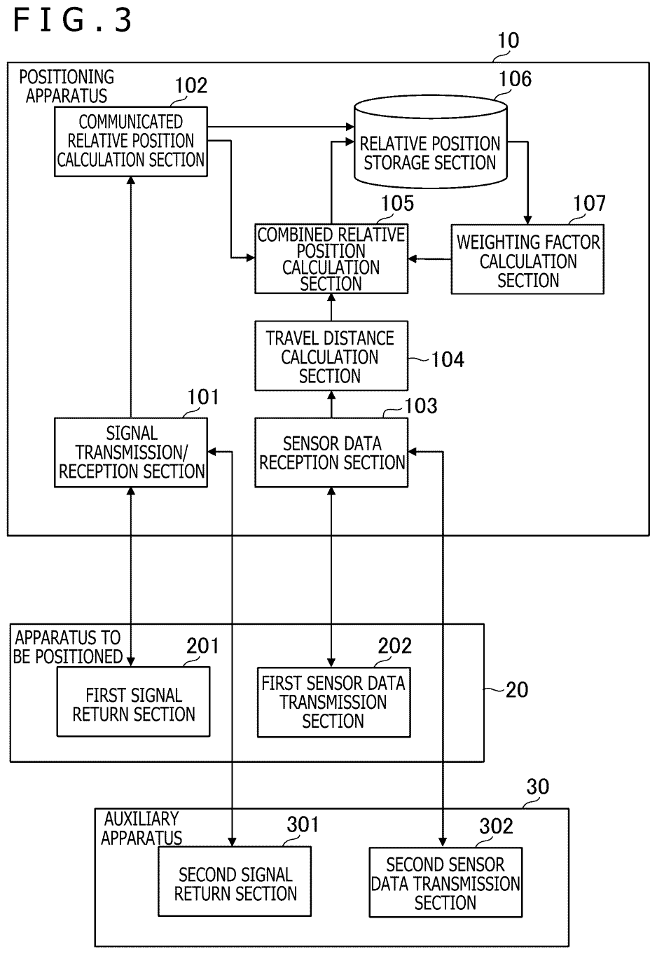

FIG. 3 is a functional block diagram indicating exemplary functions implemented by the positioning system 1. In the example depicted in the example depicted in FIG. 3, the positioning apparatus 10 functionally includes a signal transmission/reception section 101, a communicated relative position calculation section 102, a sensor data reception section 103, a travel distance calculation section 104, a combined relative position calculation section 105, a relative position storage section 106, and a weighting factor calculation section 107. The signal transmission/reception section 101, the communicated relative position calculation section 102, the sensor data reception section 103, the travel distance calculation section 104, the combined relative position calculation section 105, and the weighting factor calculation section 107 may be implemented primarily by the control section 11 of the positioning apparatus 10. The relative position storage section 106 may be implemented primarily by the storage section 12 of the positioning apparatus 10.

Also, in the example depicted in FIG. 3, the apparatus 20 to be positioned includes a first signal return section 201 and a first sensor data transmission section 202. These functions may be implemented primarily by the control section 21 of the apparatus 20 to be positioned.

Further, in the example depicted in FIG. 3, the auxiliary apparatus 30 includes a second signal return section 301 and a second sensor data transmission section 302. These functions may be implemented primarily by the control section 31 of the auxiliary apparatus 30.

The signal transmission/reception section 101 of the positioning apparatus 10 transmits a first signal (request) to the apparatus 20 to be positioned and the auxiliary apparatus 30 by using the antenna of the communication section 13. Upon receiving the first signal transmitted from the positioning apparatus 10, the first signal return section 201 of the apparatus 20 to be positioned transmits (returns) a second signal (response) to the positioning apparatus 10 by using the antenna of the communication section 23. Likewise, upon receiving the first signal transmitted from the positioning apparatus 10, the second signal return section 301 of the auxiliary apparatus 30 transmits (returns) the second signal to the positioning apparatus 10 by using the antenna of the communication section 33. The signal transmission/reception section 101 of the positioning apparatus 10 receives the second signals transmitted from the apparatus 20 to be positioned and the auxiliary apparatus 30, by using the antenna of the communication section 13.

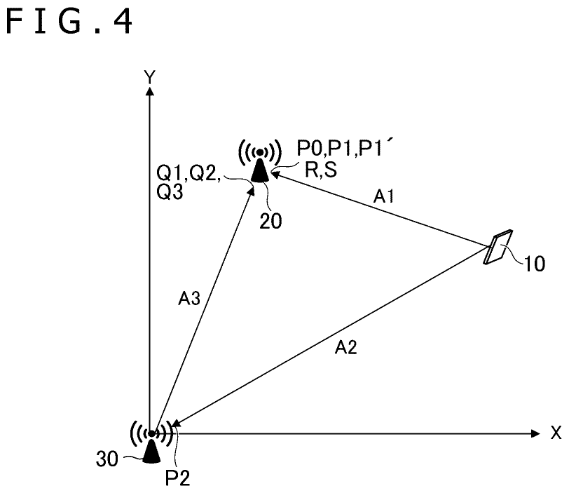

The communicated relative position calculation section 102 of the positioning apparatus 10 calculates the relative position of one apparatus with respect to the other apparatus on the basis of the communication between the two apparatuses. FIG. 4 is a diagram depicting exemplary positions of the positioning apparatus 10, the apparatus 20 to be positioned, and the auxiliary apparatus 30 in planar view. In FIG. 4, the relative position of the apparatus 20 to be positioned with respect to the positioning apparatus 10 is indicated by arrow A1. Also in FIG. 4, the relative position of the auxiliary apparatus s 30 with respect to the positioning apparatus 10 is indicated by arrow A2, and the relative position of the apparatus 20 to be positioned with respect to the auxiliary apparatus 30 is indicated by arrow A3.

The communicated relative position calculation section 102 of the positioning apparatus 10 calculates a first relative position P1, indicated by arrow A1 in FIG. 4, of the apparatus 20 to be positioned with respect to the positioning apparatus 10 on the basis of the communication between the positioning apparatus 10 (signal transmission/reception section 101) and the apparatus 20 to be positioned (first signal return section 301). Further, the communicated relative position calculation section 102 of the positioning apparatus 10 calculates a relative position P2, indicated by arrow A2 in FIG. 4, of the auxiliary apparatus 30 with respect to the positioning apparatus 10 on the basis of the communication between the positioning apparatus 10 (signal transmission/reception section 101) and the auxiliary apparatus 30 (second signal return section 301).

Explained below is the method of calculating the relative position of one apparatus with respect to the other apparatus on the basis of the communication between the two apparatuses. For example, the communicated relative position calculation section 102 calculates the distance and the angle (angle between the direction in which one of the positioning apparatus 10 and the apparatus 20 to be positioned is oriented and the direction in which the one of these apparatuses faces the other of these apparatuses) between the positioning apparatus 10 and the apparatus 20 to be positioned. On the basis of the distance and angle thus calculated, the communicated relative position calculation section 102 calculates the first relative position P1 as the relative position of the apparatus 20 to be positioned with respect to the positioning apparatus 10. In a direction similar to this, the communicated relative position calculation section 102 may calculate the relative position P2 of the auxiliary apparatus 30 with respect to the positioning apparatus 10.

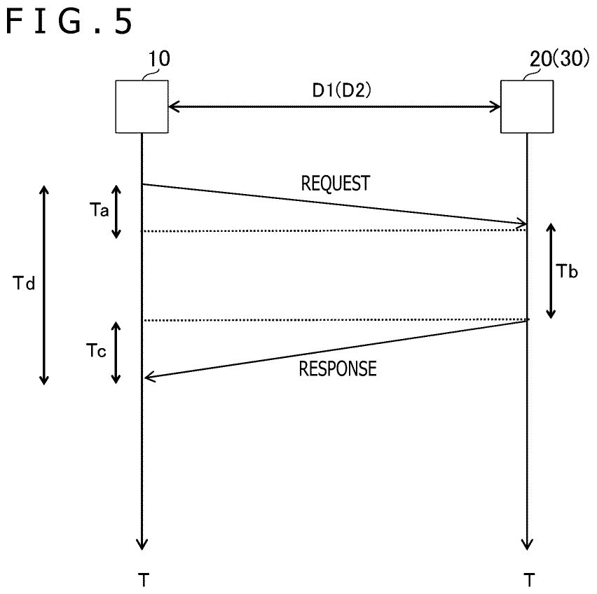

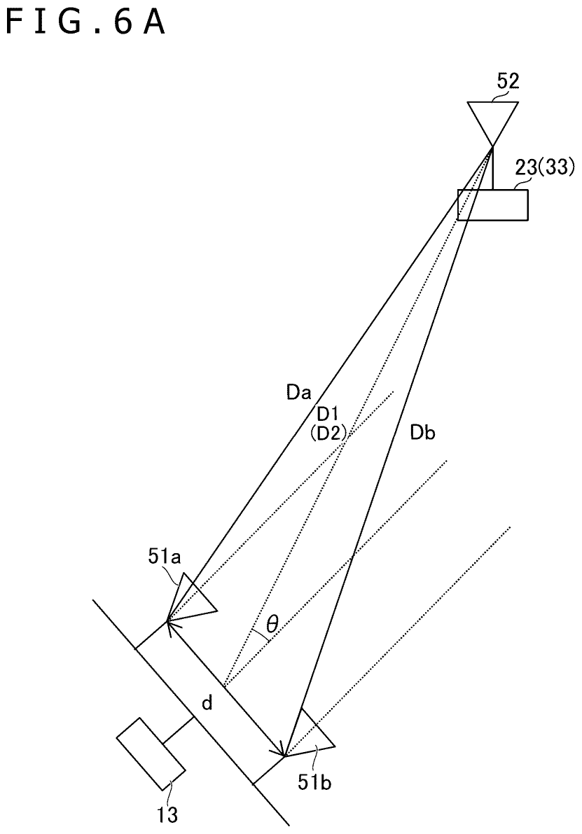

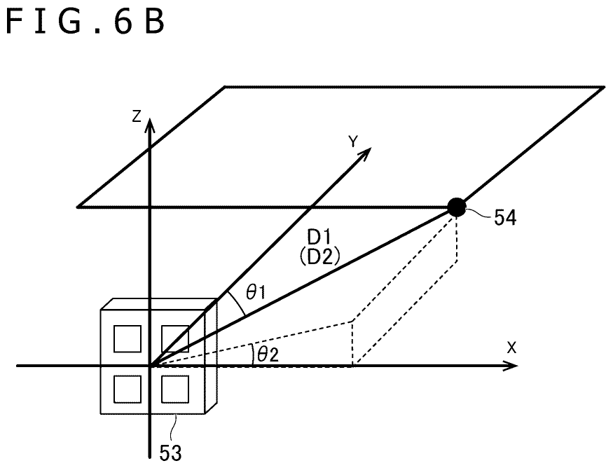

FIG. 5 is a diagram indicating an exemplary method of calculating the distance between two apparatuses. FIG. 6A is a diagram indicating an exemplary method of calculating the distance and the angle between two apparatuses. FIG. 6B is a diagram indicating another exemplary method of calculating the distance and the angle between two apparatuses.

On the basis of the time required for a signal to make a round trip between the positioning apparatus 10 and the apparatus 20 to be positioned, the communicated relative position calculation section 102 calculates a distance D1 between the positioning apparatus 10 and the apparatus 20 to be positioned. Also, on the basis of the time required for a signal to make a round trip between the positioning apparatus 10 and the auxiliary apparatus 30, the communicated relative position calculation section 102 calculates a distance D2 between the positioning apparatus 10 and the auxiliary apparatus 30.

In the example depicted in FIG. 5, T stands for elapsed time. Ta denotes the time period from when the positioning apparatus 10 (signal transmission/reception section 101) transmits the first signal (request) until the apparatus 20 to be positioned (first signal return section 201) or the auxiliary apparatus 30 (second signal return section 301) receives this signal. Tb represents the time period from when the apparatus 20 to be positioned (first signal return section 201) or the auxiliary apparatus 30 (second signal return section 301) receives the first signal until the receiving apparatus transmits (returns) the second signal (response). Tc designates the time period from when the apparatus 20 to be positioned (first signal return section 201) or the auxiliary apparatus 30 (second signal return section 301) transmits the second signal until the positioning apparatus 10 (signal transmission/reception section 101) receives this signal. Td denotes the time period from when the positioning apparatus 10 (signal transmission/reception section 101) transmits the first signal until it receives the second signal, i.e., a duration of the time periods Ta through Tc.

In the example depicted in FIG. 5, the distance D1 between the positioning apparatus 10 and the apparatus 20 to be positioned can be calculated by the formula such as D1=light speed*(Ta+Tc)/2 or D1=light speed*(Td−Tb)/2. Note that “*” stands for multiplication. The distance D2 between the positioning apparatus 10 and the auxiliary apparatus 30 can also be calculated by the same formula.

The first signal return section 201 of the apparatus 20 to be positioned and the second signal return section 301 of the auxiliary apparatus 30 may attach, for example, the time period Tb (in numeric values such as number of seconds) to the second signal (response) for transmission. As another example, the first signal return section 201 and the second signal return section 301 may attach to the second signal a clock time at which the first signal has been received and a clock time at which the second signal is transmitted. This enables the communicated relative position calculation section 102 of the positioning apparatus 10 to calculate the inter-apparatus distances D1 and D2 by identifying the time periods Ta and Tc or the time periods Td and Tb on the basis of information regarding, for example, the time period and the clock times attached to the second signal, the clock time at which the first signal has been transmitted, and the clock time at which the second signal has been received. Note that, if the time period Tb is known, the first signal return section 201 and the second signal return section 301 may transmit the second signal without attaching thereto the information regarding the time period and clock times.

In the example depicted in FIG. 6A, the communication section 13 of the positioning apparatus 10 includes a first antenna 51a and a second antenna 51b. Further, the communication section 23 of the apparatus 20 to be positioned and the communication section 33 of the auxiliary apparatus 30 each include an antenna 52 permitting wireless communication with the first antenna 51a and the second antenna 51b. Conversely, the first antenna 51a and the second antenna 51b may be included in the communication section 23 of the apparatus 20 to be positioned and the communication section 33 of the auxiliary apparatus 30, and the antenna 52 may be included in the communication section 13 of the positioning apparatus 10. The first antenna 52a and the second antenna 52b are oriented in the same direction (indicated by dotted line arrows in FIG. 6A). The first antenna 52a and the second antenna 52b are spaced a predetermined distance d apart and disposed in a direction vertically crossing the direction in which these antennas are oriented.

As indicated in FIG. 6A, when, for example, the position of the antenna 52 is not aligned with the direction in which the first antenna 51a and the second antenna 51b are oriented (when one apparatus does not face the other apparatus), there is a difference between a distance Da between the first antenna 51a and the second antenna 51b on one hand and a distance Db between the second antenna 51b and the antenna 52 on the other hand. Here, the communicated relative position calculation section 102 may obtain the distance D1 between the positioning apparatus 10 and the auxiliary apparatus 30 on the basis of a first time period T1 required for a signal to make a round trip between the first antenna 51a and the antenna 52 and a second time period T2 required for a signal to make a round trip between the second antenna 51b and the antenna 52. For example, the communicated relative position calculation section 102 may calculate the distance Da between the first antenna 51a and the antenna 52 on the basis of the first time period T1, calculate the distance Db between the second antenna 51b and the antenna 52 on the basis of the second time period T2, and calculate an average value of the distances Da and Db as the distance D1 or the distance D2 between the two apparatuses.

Further, the communicated relative position calculation section 102 may calculate an angle (azimuth angle) θ between the direction in which the positioning apparatus 10 (or auxiliary apparatus 30) is oriented and the direction in which the positioning apparatus 10 faces the auxiliary apparatus 30, on the basis of the first time period T1 required for a signal to make a round trip between the first antenna 51a and the antenna 52 and the second time period T2 required for a signal to make a round trip between the second antenna 51b and the antenna 52. For example, the angle θ can be calculated by the formula: θ−arccos((φλ)/2 πd). Here, “φ” denotes a phase difference between the signals received by the first antenna 51a and the second antenna 51b. “λ” stands for the signal wavelength, “π” for the circumference ratio, and “d” for the distance between the first antenna 51a and the second antenna 51b (see FIG. 5A). In the example depicted in FIG. 5A, on the basis of the distance and the angle θ thus calculated, the communicated relative position calculation section 102 may calculate the first relative position P1 as the relative position of the apparatus 20 to be positioned with respect to the positioning apparatus 10 and the relative position P2 of the auxiliary apparatus 30 with respect to the positioning apparatus 10.

As indicated in FIG. 6B, the communication section 13 of the positioning apparatus 10 may include an array antenna 53. The communication section 23 of the apparatus 20 to be positioned or the communication section 33 of the auxiliary apparatus 30 may include the array antenna 53. The array antenna 53 includes a first set of antennas spaced a distance apart from each other in a vertical direction (Z-axis direction in FIG. 6B) and a second set of antennas spaced a distance apart from each other in a horizontal direction (X-axis direction in FIG. 6B). The communicated relative position calculation section 102 may acquire, for each of the plurality of antennas included in the array antenna 53, the time period required for a signal to make a round trip between the antenna in question and the antenna 54 included in the other apparatus. On the basis of the plurality of time periods thus acquired, the communicated relative position calculation section 102 may calculate the distance D1 between the positioning apparatus 10 and the apparatus 20 to be positioned (or distance D2 between the positioning apparatus 10 and the auxiliary apparatus 30) as well as an azimuth angle θ1 and an elevation angle 02 between the direction in which the positioning apparatus 10 is oriented and the direction in which the positioning apparatus 10 faces the apparatus 20 to be positioned (or auxiliary apparatus 30). In this manner, the array antenna 53 is used to calculate the time periods in which a signal makes a round trip via each of the antennas, making it possible to obtain the elevation angle 02 in addition to the azimuth angle θ1. In the example depicted in FIG. 5B, the communicated relative position calculation section 102 may calculate the first relative position P1 as the relative position of the apparatus 20 to be positioned with respect to the positioning apparatus 10 and the relative position P2 of the auxiliary apparatus 30 with respect to the positioning apparatus 10 on the basis of the distance, azimuth angle θ1, and elevation angle θ2 calculated as described above.

The first sensor data transmission section 202 of the apparatus 20 to be positioned transmits, to the positioning apparatus 10, acceleration rate data output from the acceleration sensor 24 (first acceleration sensor) included in the apparatus 20 to be positioned. The first sensor data transmission section 202 may transmit, to the positioning apparatus 10, such data as the inclination and magnetism of the apparatus 20 to be positioned as well as the atmospheric pressure, the data being output from the IMU, the magnetic sensor, and the atmospheric pressure sensor, among others, on board the apparatus 20 to be positioned. Likewise, the second sensor data transmission section 302 of the auxiliary apparatus 30 transmits, to the positioning apparatus 10, acceleration rate data output from the acceleration sensor 34 (second acceleration sensor) included in the auxiliary apparatus 30. The second sensor data transmission section 302 may transmit, to the positioning apparatus 10, various kinds of data output from the IMU and the magnetic sensor, among others, on board the auxiliary apparatus 30. The sensor data reception section 103 of the positioning apparatus 10 receives the data such as acceleration rates transmitted from the first sensor data transmission section 202 and the second sensor data transmission section 302.

The travel distance calculation section 104 of the positioning apparatus 10 calculates a relative travel distance of the apparatus 20 to be positioned with respect to the auxiliary apparatus 30 on the basis of the acceleration rate of the apparatus 20 to be positioned output from the acceleration sensor 24 (first acceleration sensor) included in the apparatus 20 to be positioned and the acceleration rate output from the acceleration sensor 34 (second acceleration sensor) included in the auxiliary apparatus 30. For example, the travel distance calculation section 104 calculates a relative acceleration rate by subtracting the acceleration rate of the auxiliary apparatus 30 detected by the acceleration sensor 34 from the acceleration rate of the apparatus 20 to be positioned detected by the acceleration sensor 24. On the basis of the relative acceleration rate thus calculated, the travel distance calculation section 104 calculates the relative travel distance of the apparatus 20 to be positioned with respect to the auxiliary apparatus 30.

For example, the travel distance calculation section 104 calculates the relative travel distance of the apparatus 20 to be positioned during a sampling time period Δt from time t0 to time t1 on the basis of the relative acceleration rate in a predetermined direction. For example, a relative velocity Av can be calculated by integrating each of the relative acceleration rates in the X-axis direction and the Y-axis direction by the sampling time period Δt. The relative velocity Δv can further be integrated by the sampling time period Δt to calculate relative travel distances Δx and Δy in the X-axis direction and the Y-axis direction. The travel distance calculation section 104 may also calculate a relative travel distance Δz in the Z-axis direction.

The combined relative position calculation section 105 calculates the relative position of the apparatus 20 to be positioned with respect to the auxiliary apparatus 30 on the basis of the relative position (first relative position) P1 of the apparatus 20 to be positioned with respect to the positioning apparatus 10 calculated by the communicated relative position calculation section 102, the relative position P2 of the auxiliary apparatus 30 with respect to the positioning apparatus 10 calculated by the communicated relative position calculation section 102, and the relative travel distance of the apparatus 20 to be positioned with respect to the auxiliary apparatus 30 calculated by the travel distance calculation section 104. For example, the combined relative position calculation section 105 calculates a first relative position Q1 of the apparatus 20 to be positioned with respect to the auxiliary apparatus 30 on the basis of the relative position (first relative position) P1 of the apparatus 20 to be positioned with respect to the positioning apparatus 10 calculated by the communicated relative position calculation section 102 and the relative position P2 of the auxiliary apparatus 30 with respect to the positioning apparatus 10 calculated by the communicated relative position calculation section 102. Also, the combined relative position calculation section 105 calculates a second relative position Q2 of the apparatus 20 to be positioned with respect to the auxiliary apparatus 30 on the basis of the relative travel distance of the apparatus 20 to be positioned with respect to the auxiliary apparatus 30. Further, the combined relative position calculation section 105 calculates a relative position Q3 of the apparatus 20 to be positioned with respect to the auxiliary apparatus 30 on the basis of the two relative positions Q1 and Q2 thus calculated.

For example, the first relative position Q1 of the apparatus 20 to be positioned with respect to the auxiliary apparatus 30 can be calculated by subtracting the relative position P2 of the auxiliary apparatus 30 with respect to the positioning apparatus 10 calculated by the communicated relative position calculation section 102 from the relative position (first relative position) P1 of the apparatus 20 to be positioned with respect to the positioning apparatus 10 calculated by the communicated relative position calculation section 102. Further, the second relative position Q2 of the apparatus 20 to be positioned with respect to the auxiliary apparatus 30 can be calculated, for example, by subtracting the position (initial position) of the auxiliary apparatus 30 at a measurement starting point in time from the sum of the relative travel distances of the apparatus 20 to be positioned at intervals of the sampling time period Δt from the measurement starting point in time to the present moment. The control section 11 of the positioning apparatus 10 may acquire information regarding the initial position of the auxiliary apparatus 30.

For example, the combined relative position calculation section 105 may calculate the relative position Q3 of the apparatus 20 to be positioned with respect to the auxiliary apparatus 30 by the formula: Q3=Q1*K1+Q2*K2. Here, K1 and K2 denote weighting factors.

The weighting factor calculation section 107 calculates weighting factors such as K1 and K2. That is, the weighting factor calculation section 107 calculates the weighting factors regarding the two relative positions Q1 and Q2 calculated with regard to the apparatus 20 to be positioned. Further, the relative position storage section 106 stores information regarding a plurality of relative positions Q1 and a plurality of relative positions Q2 calculated during the sampling time period Δt, as the information by which the weighting factor calculation section 107 calculates the weighting factors K1 and K2. The weighting factor calculation section 107 calculates the weighting factor K1 regarding the relative position Q1 and the weighting factor K2 regarding the relative position Q2 on the basis of the plurality of relative positions Q1 and Q2 stored into the relative position storage section 106 during the sampling time period Δt.

For example, the weighting factor calculation section 107 calculates the weighting factors K1 and K2 on the basis of a dispersion of a plurality of relative positions Q1 during the sampling time period Δt and a dispersion of a plurality of elative positions Q2 during the sampling time period Δt. In this case, the weighting factor calculation section 107 calculates the dispersion of the relative positions Q1 on the basis of the plurality of relative positions Q1 stored into the relative position storage section 106 during the sampling time period Δt, and calculates the dispersion of the relative positions Q2 on the basis of the plurality of relative positions Q2 stored into the relative position storage section 106 during the sampling time period Δt.

The weighting factors K1 and K2 can be calculated by the formulas such as K1=σ_{Q2}²/(σ_{Q1}²+σ_{Q2}²) and K2=σ_{Q1}²/(σ_{Q1}²+σ_{Q2}²), for example. Here, σ_{Q1}² denotes the dispersion of the relative positions Q1 calculated during the sampling time period Δt and stored into the relative position storage section 106. Further, σ_{Q2}² represents the dispersion of the relative positions Q2 calculated during the sampling time period Δt and stored into the relative position storage section 106.

The weighting factor calculation section 107 may alternatively calculate the weighting factors K1 and K2 on the basis of an average value or a median value of the plurality of relative positions Q1 and Q2 during the sampling time period Δt. The weighting factor calculation section 107 may calculate the average value or the median value of the relative positions Q1 and Q2 on the basis of the plurality of relative positions Q1 and Q2 stored into the relative position storage section 106 during the sampling time period Δt.

Also, the combined relative position calculation section 105 calculates a second relative position R as the relative position of the apparatus 20 to be positioned with respect to the positioning apparatus 10 on the basis of the relative position Q3 of the apparatus 20 to be positioned with respect to the auxiliary apparatus 30 calculated by use of the weighting factors K1 and K2, for example, and the relative position P2 of the auxiliary apparatus 30 with respect to the positioning apparatus 10 calculated by the communicated relative position calculation section 102. For example, the combined relative position calculation section 105 may calculate the second relative position R as the relative position of the apparatus 20 to be positioned with respect to the positioning apparatus 10 by adding the relative position Q3 of the apparatus 20 to be positioned with respect to the auxiliary apparatus 30 to the relative position P2 of the auxiliary apparatus 30 with respect to the positioning apparatus 10.

The combined relative position calculation section 105 calculates an ultimate relative position S of the apparatus 20 to be positioned with respect to the positioning apparatus 10 on the basis of the first relative position P1 as the relative position of the apparatus 20 to be positioned with respect to the positioning apparatus 10 calculated by the communicated relative position calculation section 102 and the second relative position R as the calculated relative position of the apparatus 20 to be positioned with respect to the positioning apparatus 10. For example, the combined relative position calculation section 105 may calculate the ultimate relative position S of the apparatus 20 to be positioned by the formula: S=P1*L1+R*L2. Here, L1 and L2 denote weighting factors.

In addition to the above-mentioned weighting factors K1 and K2, the weighting factor calculation section 107 calculates weighting factors such as L1 and L2. That is, the weighting factor calculation section 107 calculates the weighting factors regarding the two relative positions P1 and R calculated with regard to the apparatus 20 to be positioned. Further, the relative position storage section 106 stores information regarding the plurality of relative positions P1 and the plurality of relative positions R calculated during the sampling time period Δt, as the information by which the weighting factor calculation section 107 calculates the weighting factors L1 and L2. The weighting factor calculation section 107 calculates the weighing factor L1 (first weighting factor) regarding the first relative position P1 and the weighting factor L2 (second weighting factor) regarding the second relative position R on the basis of the plurality of first relative positions P1 and the plurality of second relative positions R stored into the relative position storage section 106 during the sampling time period Δt.

For example, the weighting factor calculation section 107 calculates the weighting factors L1 and L2 on the basis of the dispersion of the plurality of relative positions P1 during the sampling time period Δt and the dispersion of the plurality of relative positions R during the sampling time period Δt, the dispersions being stored into the relative position storage section 106. In this case, the weighting factor calculation section 107 calculates the dispersion of the relative positions P1 on the basis of the plurality of relative positions P1 stored into the relative position storage section 106 during the sampling time period Δt. The weighting factor calculation section 107 also calculates the dispersion of the relative positions R on the basis of the plurality of relative positions R stored into the relative position storage section 106 during the sampling time period Δt. The weighting factors L1 and L2 can be calculated by the formulas such as L1=σ_{R}²/(σ_{P1}²+σ_{R}²) and L2=σ_{P1}²/(σ_{P1}²+σ_{R}²), for example. Here, σ_{P1}² denotes the dispersion of the relative positions P1 calculated during the sampling time period Δt and stored into the relative position storage section 106. Further, σ_{R}² represents the dispersion of the relative positions R calculated during the sampling time period Δt and stored into the relative position storage section 106.

Also, the weighting factor calculation section 107 may calculate the weighting factors L1 and L2 on the basis of an average value or a median value of the plurality of relative positions P1 and R calculated during the sampling time period Δt. The weighting factor calculation section 107 may calculate the average value or the median value of the relative positions P1 and R on the basis of the plurality of relative positions P1 and R stored into the relative position storage section 106 during the sampling time period Δt.

As discussed above, the control section 11 of the positioning apparatus 10 calculates the relative travel distance of the apparatus 20 to be positioned with respect to the auxiliary apparatus 30 on the basis of the acceleration rates output from the acceleration sensors 24 and 34 in the apparatus 20 to be positioned and the auxiliary apparatus 30. Then, on the basis of the relative travel distance thus calculated, the control section 11 calculates the relative positions Q2 and Q3 of the apparatus 20 to be positioned with respect to the auxiliary apparatus 30. Further, on the basis of the relative position Q3, the control section 11 calculates the relative positions R and S of the apparatus 20 to be positioned with respect to the positioning apparatus 10. In this manner, the accuracy of positioning the apparatus 20 to be positioned can be improved.

On the basis of the travel distance of the apparatus 20 to be positioned, the combined relative position calculation section 105 of the positioning apparatus 10 may correct the first relative position P1 as the relative position of the apparatus 20 to be positioned with respect to the positioning apparatus 10 calculated by the communicated relative position calculation section 102. In this case, the travel distance calculation section 104 of the positioning apparatus 10 may calculate the travel distance of the apparatus 20 to be positioned on the basis of the acceleration rate output from the acceleration sensor 24 (first acceleration sensor) on board the apparatus 20 to be positioned.

The combined relative position calculation section 105 may calculate the current position of the apparatus 20 to be positioned and, on the basis of this current position, calculate a relative position P0 of the apparatus 20 to be positioned with respect to the positioning apparatus 10. For example, the current position of the apparatus 20 to be positioned can be calculated by subtracting the position (initial position) of the apparatus 20 to be positioned at the measurement starting point in time from the sum of the travel distances of the apparatus 20 to be positioned at intervals of the sampling time period Δt from the measurement starting point in time to the present moment. Also, the travel distance calculation section 104 can calculate the relative position P0 of the apparatus 20 to be positioned with respect to the positioning apparatus 10 by subtracting the current position of the positioning apparatus 10 from the current position of the apparatus 20 to be positioned. The control section 11 of the positioning apparatus 10 may acquire information regarding the initial position of the apparatus 20 to be positioned. Also, the control section 11 of the positioning apparatus 10 may acquire the current position of the positioning apparatus 10 on the basis of the information from the sensors, for example, on board the positioning apparatus 10.

For example, the combined relative position calculation section 105 may calculate (correct) a first relative position P1′ of the apparatus 20 to be positioned by the formula: P1′=P1*M1+P0*M2. Here, M1 and M2 denote weighting factors.

The weighting factor calculation section 107 may calculate the weighting factors M1 and M2 regarding the relative positions P1 and P0. Further, the relative position storage section 106 may store information regarding the plurality of relative positions P1 and P0 calculated during the sampling time period Δt, as the information by which the weighting factor calculation section 107 calculates the weighting factors M1 and M2. The weighting factor calculation section 107 calculates the weighting factor M1 (third weighting factor) regarding the relative position P1 on the basis of the plurality of relative positions P1 stored into the relative position storage section 106 during the sampling time period Δt. The weighting factor calculation section 107 may also calculate the weighting factor M2 (fourth weighting factor) regarding the relative position P0 on the basis of the plurality of relative positions P0 stored into the relative position storage section 106 during the sampling time period Δt.

The weighting factor calculation section 107 may calculate the weighting factor M1 on the basis of the dispersion of the plurality of relative positions P1 stored into the relative position storage section 106 during the sampling time period Δt. The weighting factor calculation section 107 may further calculate the weighting factor M2 on the basis of the dispersion of the plurality of relative positions P0 stored into the relative position storage section 106 during the sampling time period Δt. The weighting factors M1 and M2 can be calculated by the formulas such as M1=σ_{P0}²/(σP₁²+σ_{P0}²) and M2=σ_{P1}²/(σ_{P1}²+σ_{P0}²), for example. Here, σ_{P1}² denotes the dispersion of the relative positions P1 during the sampling time period Δt as discussed above. Further, σ_{P0}² represents the dispersion of the relative positions P0 calculated during the sampling time period Δt and stored into the relative position storage section 106.

The combined relative position calculation section 105 may calculate the ultimate relative position S of the apparatus 20 to be positioned with respect to the positioning apparatus 10 on the basis of the corrected first relative position P1′ and the second relative position R as the calculated relative position of the apparatus 20 to be positioned with respect to the positioning apparatus 10. In this manner, the accuracy of positioning the apparatus 20 to be positioned can also be improved by calculating the ultimate relative position S of the apparatus 20 to be positioned on the basis of the relative position P1′ corrected by the travel distance of the apparatus 20 to be positioned.

For example, the combined relative position calculation section 105 may calculate the ultimate relative position S of the apparatus 20 to be positioned by the formula: S=P1′*L1′+R*L2′. Here, L1′ and L2′ denote weighting factors. The weighting factors L1′ and L2′ may be calculated by the formulas such as L1′=σ_{R}²/(σ_{P1′}²+σ_{R}²) and L2=σ_{P1′}²/(σ_{P1′}²+σ_{R}²), for example. Here, σ_{P1′}² denotes the dispersion of the relative positions P1′ calculated (corrected) during the sampling time period Δt and stored into the relative position storage section 106. Further, σ_{R} represents the dispersion of the relative positions R during the sampling time period Δt as discussed above. As with σ_{R}, σ_{P1′}² can be calculated by storing, into the relative position storage section 106, the plurality of relative positions P1′ corrected by the combined relative position calculation section 105 during the sampling time period Δt.

### 4. Flowchart

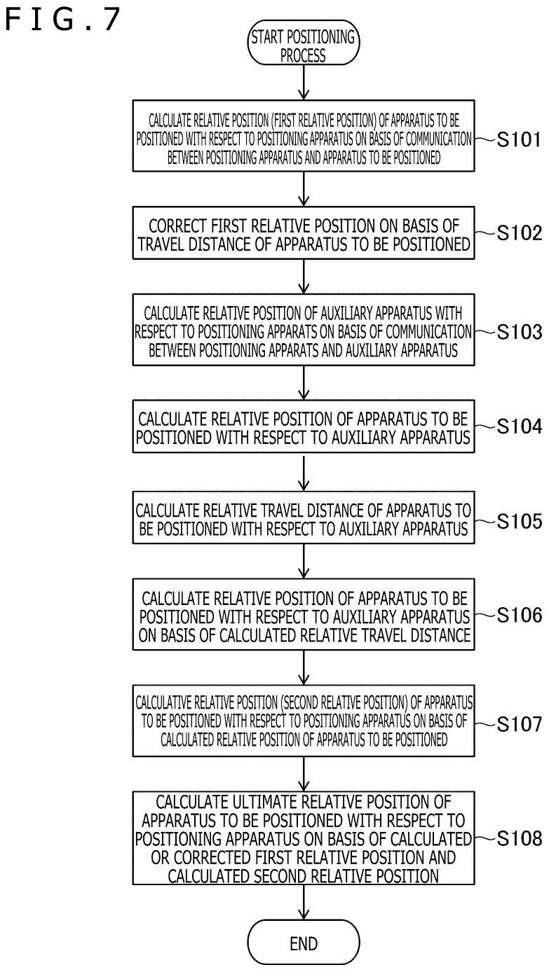

FIG. 7 is a flowchart indicating an exemplary flow of the positioning process performed by the positioning system 1. The positioning process in FIG. 7 may be performed repeatedly by the control section 11 of the positioning apparatus 10 while the control section 11 is carrying out an application, for example.

First, as indicated in FIG. 7, the communicated relative position calculation section 102 of the positioning apparatus 10 calculates the relative position (first relative position) P1 of the apparatus 20 to be positioned with respect to the positioning apparatus 10 on the basis of communication between the positioning apparatus 10 and the apparatus 20 to be positioned (step S101). In step S101, the communicated relative position calculation section 102 calculates the relative position of the apparatus 20 to be positioned with respect to the positioning apparatus 10 on the basis of the time period from when the first signal (request) is transmitted from the signal transmission/reception section 101 of the positioning apparatus 10 until the second signal (response) is transmitted (returned) by the first signal return section 201 of the apparatus 20 to be positioned.

Also, in step S101, the communicated relative position calculation section 102 stores the calculated relative position P1 of the apparatus 20 to be positioned with respect to the positioning apparatus 10 into the relative position storage section 106 (storage apparatus). When the process of step S101 is repeated, information regarding the plurality of relative positions P1 is stored into the relative position storage section 106.

Next, the combined relative position calculation section 105 of the positioning apparatus 10 corrects the relative position P1 of the apparatus 20 to be positioned with respect to the positioning apparatus 10 on the basis of the travel distance of the apparatus 20 to be positioned (step S102). It is not mandatory for the control section 11 of the positioning apparatus 10 to carry out the process of step S102.

In step S102, the travel distance calculation section 104 of the positioning apparatus 10 calculates the travel distance of the apparatus 20 to be positioned on the basis of the acceleration rate output from the acceleration sensor 24 (first acceleration sensor) on board the apparatus 20 to be positioned and transmitted from the first sensor data transmission section 202 of the apparatus 20 to be positioned. The combined relative position calculation section 105 then calculates the current position of the apparatus 20 to be positioned based on the travel distance of the apparatus 20 to be positioned and, on the basis of this current position, calculates the relative position P0 of the apparatus 20 to be positioned with respect to the positioning apparatus 10.

Also, in step S102, the combined relative position calculation section 105 stores the calculated relative position P0 of the apparatus 20 to be positioned with respect to the positioning apparatus 10 into the relative position storage section 106 (storage apparatus). When the process of step S102 is repeated, information regarding the plurality of relative positions P0 is stored into the relative position storage section 106.

Also, in step S102, the weighting factor calculation section 107 calculates the weighting factors M1 and M2 regarding the relative positions P1 and P0. The weighting factor calculation section 107 calculates the weighting factors M1 and M2 on the basis of the dispersion of the plurality of relative positions P1 and the dispersion of the plurality of relative positions P0, the dispersions being stored into the relative position storage section 106 during the sampling time period Δt. Then, on the basis of the relative position P0 and the weighting factors M1 and M2, the combined relative position calculation section 105 corrects the relative position P1 calculated in step S101 to the relative position P1′.

Also, in step S102, the combined relative position calculation section 105 stores the calculated relative position P1′ into the relative position storage section 106. When the process of step S102 is repeated, information regarding the plurality of relative positions P1′ is stored into the relative position storage section 106.

The communicated relative position calculation section 102 of the positioning apparatus 10 then calculates the relative position P2 of the auxiliary apparatus 30 with respect to the positioning apparatus 10 on the basis of the communication between the positioning apparatus 10 and the auxiliary apparatus 30 (step S103). In step S103, the communicated relative position calculation section 102 calculates the relative position P2 of the auxiliary apparatus 30 with respect to the positioning apparatus 10 on the basis of the time period from when the first signal (request) is transmitted from the signal transmission/reception section 101 of the positioning apparatus 10 until the second signal (response) is transmitted (returned) by the second signal return section 301 of the auxiliary apparatus 30.

The combined relative position calculation section 105 of the positioning apparatus 10 then calculates the first relative position Q1 of the apparatus 20 to be positioned with respect to the auxiliary apparatus 30 on the basis of the relative position (first relative position) P1 of the apparatus to be positioned with respect to the positioning apparatus 10 calculated in step S101 and the relative position P2 of the auxiliary apparatus 30 with respect to the positioning apparatus 10 calculated in step S103 (step S104). In step S104, the combined relative position calculation section 105 calculates the relative position Q1 of the apparatus 20 to be positioned with respect to the auxiliary apparatus 30 by subtracting the relative position P2 of the auxiliary apparatus 30 with respect to the positioning apparatus 10 from the relative position P1 of the apparatus 20 to be positioned with respect to the positioning apparatus 10, for example.

Also, in step S104, the combined relative position calculation section 105 stores the calculated relative position Q1 into the relative position storage section 106. When the process of step S104 is repeated, information regarding the plurality of relative positions Q1 is stored into the relative position storage section 106.

The travel distance calculation section 104 of the positioning apparatus 10 then calculates the relative travel distance of the apparatus 20 to be positioned with respect to the auxiliary apparatus 30 on the basis of the acceleration rate output from the acceleration sensor 24 included in the apparatus 20 to be positioned and the acceleration rate output from the acceleration sensor 34 included in the auxiliary apparatus 30 (step S105). The positioning apparatus 10 acquires the acceleration rate transmitted from the first sensor data transmission section 202 of the apparatus 20 to be positioned and the acceleration rate transmitted from the second sensor data transmission section 302 of the auxiliary apparatus 30 through reception by the sensor data reception section 103. In step S105, the travel distance calculation section 104 of the positioning apparatus 10 calculates the relative travel distance of the apparatus 20 to be positioned with respect to the auxiliary apparatus 30 during the sampling time period Δt, for example.

The combined relative position calculation section 105 of the positioning apparatus 10 then calculates the relative position Q2 of the apparatus 20 to be positioned with respect to the auxiliary apparatus 30 on the basis of the relative travel distance of the apparatus 20 to be positioned with respect to the auxiliary apparatus 30 calculated in step S105 (step S106). In step S106, the combined relative position calculation section 105 calculates the relative position Q2 of the apparatus 20 to be positioned with respect to the auxiliary apparatus 30 by subtracting the position (initial position) of the auxiliary apparatus 30 at the measurement starting point in time from the sum of the relative travel distances of the apparatus 20 to be positioned at intervals of the sampling time period Δt from the measurement starting point in time to the present moment, for example.

Also, in step S106, the combined relative position calculation section 105 stores the calculated relative position Q2 into the relative position storage section 106. When the process of step S106 is repeated, information regarding the plurality of relative positions Q2 is stored into the relative position storage section 106.

The combined relative position calculation section 105 of the positioning apparatus 10 then calculate the relative position (second relative position) R of the apparatus to be positioned with respect to the positioning apparatus 10 on the basis of the two relative positions Q1 and Q2 of the apparatus 20 to be positioned with respect to the auxiliary apparatus 30 calculated in step S104 and step S106 (step S107). In step S107, the combined relative position calculation section 105 calculates the relative position Q3 of the apparatus 20 to be positioned with respect to the auxiliary apparatus 30 on the basis of the two calculated relative positions Q1 and Q2. The combined relative position calculation section 105 then calculates the relative position R of the apparatus 20 to be positioned with respect to the positioning apparatus 10 on the basis of the calculated relative position Q3 and the relative position P2 of the auxiliary apparatus 30 with respect to the positioning apparatus 10 calculated in step S103.

In step S107, the weighting factor calculation section 107 calculates the weighting factor K1 regarding the relative position Q1 of the apparatus 20 to be positioned calculated in step S104 and the weighting factor K2 regarding the relative position Q2 of the apparatus 20 to be positioned calculated in step S106. The weighting factor calculation section 107 calculates the weighting factors K1 and K2 on the basis of the dispersion of the plurality of relative positions Q1 and the dispersion of the plurality of relative positions Q2, the dispersions being stored into the relative position storage section 106 during the sampling time period Δt. The combined relative position calculation section 105 then calculates the relative position Q3 of the apparatus 20 to be positioned with respect to the auxiliary apparatus 30 and the relative position R of the apparatus 20 to be positioned with respect to the positioning apparatus 10 on the basis of the relative positions Q1 and Q1 and the weighting factors K1 and K2.

Also, in step S107, the combined relative position calculation section 105 stores the calculated relative position R into the relative position storage section 106. When the process of step S107 is repeated, information regarding the plurality of relative positions R is stored into the relative position storage section 106.

Lastly, the combined relative position calculation section 105 of the positioning apparatus 10 calculates the ultimate relative position S of the apparatus 20 to be positioned with respect to the positioning apparatus 10 on the basis of either the relative position (first relative position) P1 of the apparatus 20 to be positioned with respect to the positioning apparatus 10 calculated in step S101 or the relative position (first relative position) P1′ of the apparatus 20 to be positioned with respect to the positioning apparatus 10 corrected in step S102 and also on the basis of the relative position (second relative position) R of the apparatus 20 to be positioned with respect to the positioning apparatus 10 calculated in step S107 (step S108).

In step S108, the weighting factor calculation section 107 calculates the weighting factor L1 regarding the first relative position P1 calculated in step S101 or the weighting factor L1′ regarding the first relative position P1′ corrected in step S102. The weighting factor calculation section 107 also calculates the weighting factor L2 (or L2′) regarding the second relative position R calculated in step S107. The weighting factor calculation section 107 calculates the weighting factors L1 and L2 (or L1′ and L2′) on the basis of the dispersion of the plurality of relative positions P1 or P1′ and the dispersion of the plurality of relative positions R, the dispersions being stored into the relative position storage section 106 during the sampling time period Δt. The combined relative position calculation section 105 then calculates the ultimate relative position S of the apparatus 20 to be positioned with respect to the positioning apparatus 10 on the basis of the first relative position P1 or P1′, the second relative position R, and the weighting factors L1 and L2 or the weighting factors L1′ and L2′. In this manner, the accuracy of positioning the apparatus 20 to be positioned can be improved by calculating the ultimate relative position S of the apparatus 20 to be positioned on the basis of the communication between the two apparatuses and the acceleration rates output from the acceleration sensors 24 and 34 in the apparatus 20 to be positioned and the auxiliary apparatus 30.

### 5. Conclusion

(1) As described above in the present disclosure, in the positioning system 1, the communicated relative position calculation section 102 of the positioning apparatus 10 calculates, on the basis of wireless communication between the positioning apparatus 10 and the apparatus 20 to be positioned separated from the positioning apparatus 10, the first relative position P1 as the relative position of the apparatus 20 to be positioned with respect to the positioning apparatus 10. The communicated relative position calculation section 102 calculates, on the basis of wireless communication between the positioning apparatus 10 and the auxiliary apparatus 30 separated from the positioning apparatus 10 and from the apparatus 20 to be positioned, the relative position P2 of the auxiliary apparatus 30 with respect to the positioning apparatus 10. The travel distance calculation section 104 of the positioning apparatus 10 calculates the relative travel distance of the apparatus 20 to be positioned with respect to the auxiliary apparatus 30 on the basis of the acceleration rate output from the acceleration sensor 24 included in the apparatus 20 to be positioned and the acceleration rate output from the acceleration sensor 34 included in the auxiliary apparatus 30. The combined relative position calculation section 105 of the positioning apparatus 10 calculates the relative position Q3 of the apparatus 20 to be positioned with respect to the auxiliary apparatus 30 on the basis of the first relative position P1, the calculated relative position P2 of the auxiliary apparatus 30 with respect the positioning apparatus 10, and the relative travel distance of the apparatus 20 to be positioned. The combined relative position calculation section 105 calculates the second relative position R as the relative position of the apparatus 20 to be positioned with respect to the positioning apparatus 10 on the basis of the calculated relative position P2 of the auxiliary apparatus 30 with respect to the positioning apparatus 10 and the calculated relative position Q3 of the apparatus 20 to be positioned with respect to the auxiliary apparatus 30. The combined relative position calculation section 105 calculates the relative position S of the apparatus 20 to be positioned with respect to the positioning apparatus 10 on the basis of the first relative position P1 and the second relative position R. In this manner, the accuracy of positioning the apparatus 20 to be positioned can be improved.

(6) Further, by the positioning method, as described above in the present disclosure, the communicated relative position calculation section 102 of the positioning apparatus 10 is caused to calculate, on the basis of wireless communication between the positioning apparatus 10 and the apparatus 20 to be positioned separated from the positioning apparatus 10, the first relative position P1 as the relative position of the apparatus 20 to be positioned with respect to the positioning apparatus 10. The communicated relative position calculation section 102 is also caused to calculate, on the basis of wireless communication between the positioning apparatus 10 and the auxiliary apparatus 30 separated from the positioning apparatus 10 and from the apparatus 20 to be positioned, the relative position P2 of the auxiliary apparatus 30 with respect to the positioning apparatus 10. In addition, the travel distance calculation section 104 of the positioning apparatus 10 is caused to calculate the relative travel distance of the apparatus 20 to be positioned with respect to the auxiliary apparatus 30 on the basis of the acceleration rate output from the acceleration sensor 24 included in the apparatus 20 to be positioned and the acceleration rate output from the acceleration sensor 34 included in the auxiliary apparatus 30. Moreover, the combined relative position calculation section 105 of the positioning apparatus 10 is caused to calculate the relative position Q3 of the apparatus 20 to be positioned with respect to the auxiliary apparatus 30 on the basis of the first relative position P1, the calculated relative position P2 of the auxiliary apparatus 30 with respect the positioning apparatus 10, and the relative travel distance of the apparatus 20 to be positioned. The combined relative position calculation section 105 is also caused to calculate the second relative position R as the relative position of the apparatus 20 to be positioned with respect to the positioning apparatus 10 on the basis of the calculated relative position P2 of the auxiliary apparatus 30 with respect to the positioning apparatus 10 and the calculated relative position Q3 of the apparatus 20 to be positioned with respect to the auxiliary apparatus 30. The combined relative position calculation section 105 is further caused to calculate the relative position S of the apparatus 20 to be positioned with respect to the positioning apparatus 10 on the basis of the first relative position P1 and the second relative position R. In this manner, the accuracy of positioning the apparatus 20 to be positioned can be improved.

(2) In the positioning system 1 stated in paragraph (1) above, the communicated relative position calculation section 102 and the combined relative position calculation section 105 of the positioning apparatus 10 may store the first relative position P1 and the second relative position R into the relative position storage section 106 (storage apparatus). The weighting factor calculation section 107 of the positioning apparatus 10 may calculate the first weighting factor L1 regarding the first relative position P1 and the second weighting factor L2 regarding the second relative position R on the basis of the plurality of first relative positions P1 and the plurality of second relative positions R stored into the relative position storage section 106 during a given sampling time period Δt. The combined relative position calculation section 105 may calculate the relative position of the apparatus 20 to be positioned with respect to the positioning apparatus 10 on the basis of the first relative position P1, the first weighting factor L1, the second relative position R, and the second weighting factor L2. This makes it possible to further improve the accuracy of positioning the apparatus 20 to be positioned.

(3) In the positioning system 1 stated in paragraph (2) above, the weighting factor calculation section 107 of the positioning apparatus 10 may calculate the dispersion of the first relative positions P1 on the basis of the plurality of first relative positions P stored into the relative position storage section 106 during the given sampling time period Δt. The weighting factor calculation section 107 may calculate the dispersion of the second relative positions R on the basis of the plurality of second relative positions R stored into the relative position storage section 106 during the given sampling time period Δt. The weighting factor calculation section 107 may calculate the first weighting factor L1 and the second weighting factor L2 on the basis of the dispersion of the first relative positions P1 and the dispersion of the second relative positions R. This makes it possible to further improve the accuracy of positioning the apparatus 20 to be positioned.

(4) In the positioning system 1 stated in any one of paragraphs (1) through (3) above, the travel distance calculation section 104 of the positioning apparatus 10 may calculate the travel distance of the apparatus 20 to be positioned on the basis of the acceleration rate output from the acceleration sensor 24 of the apparatus 20 to be positioned. The combined relative position calculation section 105 of the positioning apparatus 10 may correct the first relative position P1 on the basis of the calculated travel distance of the apparatus 20 to be positioned. The combined relative position may calculate the relative position of the apparatus 20 to be positioned with respect to the positioning apparatus 10 on the basis of the corrected first relative position P1′ and the second relative position R. This makes it possible to further improve the accuracy of positioning the apparatus 20 to be positioned.

(5) In the positioning system 1 stated in paragraph (4) above, the combined relative position calculation section 105 of the positioning apparatus 10 may calculate the relative position P0 of the apparatus 20 to be positioned with respect to the positioning apparatus 10 on the basis of the first relative position P1 and the calculated travel distance of the apparatus 20 to be positioned, and store the calculated relative position P0 into the relative position storage section 106. The weighting factor calculation section 107 of the positioning apparatus 10 may calculate, on the basis of the plurality of first relative positions P1 stored into the relative position storage section 106 during the given sampling time period Δt and the relative position P0 of the apparatus 20 to be positioned based on the plurality of travel distances thereof, the third weighting factor M1 regarding the first relative position P1 and the fourth weighting factor M2 regarding the relative position P0 of the apparatus 20 to be positioned based on the travel distance of the apparatus 20 to be positioned. The combined relative position calculation section 105 may correct the first relative position P1 on the basis of the first relative position P1, the third weighting factor M1, the relative position P0 of the apparatus 20 to be positioned based on the travel distance of the apparatus 20 to be positioned, and the fourth weighting factor M2. This makes it possible to further improve the accuracy of positioning the apparatus 20 to be positioned.

The present disclosure is not limited to the embodiment discussed above. For example, modifications and variations of the above-described embodiment may also fall within the technical scope of the present disclosure.

In the embodiment, there has been explained an example in which the positioning apparatus 10 includes the signal transmission/reception section 101, the communicated relative position calculation section 102, the sensor data reception section 103, the travel distance calculation section 104, the combined relative position calculation section 105, the relative position storage section 106, and the weighting factor calculation section 107. These functions may alternatively be included either in the apparatus 20 to be positioned or in the auxiliary apparatus 30. For example, for example, when information regarding the time required for a signal to make a round trip between two apparatuses is transmitted either to the apparatus 20 to be positioned or to the auxiliary apparatus 30, the apparatus having received the information can calculate the relative position of one of the two apparatuses with respect to the other apparatus on the basis of the round-trip time between the two apparatuses. Further, when information such as the acceleration rate from the acceleration sensor 34 of the auxiliary apparatus 30 is transmitted to the apparatus 20 to be positioned, the apparatus 20 to be positioned can calculate the relative travel distance of the apparatus 20 to be positioned with respect to the auxiliary apparatus 30 on the basis of the acceleration rate of the auxiliary apparatus 30 and the acceleration rate of the apparatus 20 to be positioned. Conversely, when information such as the acceleration rate from the acceleration sensor 24 of the apparatus 20 to be positioned is transmitted to the auxiliary apparatus 30, the auxiliary apparatus 30 can calculate the relative travel distance of the apparatus 20 to be positioned with respect to the auxiliary apparatus 30.

In the embodiment, there has been explained another example in which the positioning apparatus 10 includes the signal transmission/reception section 101 while the apparatus 20 to be positioned and the auxiliary apparatus 30 include the first and the second signal return sections 201 and 301, respectively. The embodiment is not limited to this example, and the apparatus 20 to be positioned and the auxiliary apparatus 30 may each include a signal transmission/reception section, and the positioning apparatus 10 may include a signal return section, for example. This arrangement also makes it possible to calculate the relative position of one of two apparatuses with respect to the other apparatus on the basis of the time required for a signal to make a round trip between the two apparatuses.

1. A positioning system comprising:
at least one processor,
wherein the at least one processor calculates, on a basis of wireless communication between a positioning apparatus and an apparatus to be positioned separated from the positioning apparatus, a first relative position as a relative position of the apparatus to be positioned with respect to the positioning apparatus,
the at least one processor calculates, on a basis of wireless communication between the positioning apparatus and an auxiliary apparatus separated from the positioning apparatus and from the apparatus to be positioned, a relative position of the auxiliary apparatus with respect to the positioning apparatus,
the at least one processor calculates a relative travel distance of the apparatus to be positioned with respect to the auxiliary apparatus on a basis of an acceleration rate output from a first acceleration sensor included in the apparatus to be positioned and an acceleration rate output from a second acceleration sensor included in the auxiliary apparatus,
the at least one processor calculates a relative position of the apparatus to be positioned with respect to the auxiliary apparatus on a basis of the first relative position, the calculated relative position of the auxiliary apparatus with respect to the positioning apparatus, and the relative travel distance,
the at least one processor calculates a second relative position as a relative position of the apparatus to be positioned with respect to the positioning apparatus on a basis of the calculated relative position of the auxiliary apparatus with respect to the positioning apparatus and the calculated relative position of the apparatus to be positioned with respect to the auxiliary apparatus, and
the at least one processor calculates a relative position of the apparatus to be positioned with respect to the positioning apparatus on a basis of the first relative position and the second relative position.

2. The positioning system according to claim 1,
wherein the at least one processor stores the first relative position and the second relative position into a storage apparatus,
the at least one processor calculates a first weighting factor regarding the first relative position and a second weighting factor regarding the second relative position on a basis of a plurality of the first relative positions and a plurality of the second relative positions stored into the storage apparatus during a given sampling time period, and
the at least one processor calculates a relative position of the apparatus to be positioned with respect to the positioning apparatus on a basis of the first relative position, the first weighting factor, the second relative position, and the second weighting factor.

3. The positioning system according to claim 2,
wherein the at least one processor calculates a dispersion of the first relative positions on a basis of the plurality of the first relative positions stored into the storage apparatus during the given sampling time period,
the at least one processor calculates a dispersion of the second relative positions on a basis of the plurality of the second relative positions stored into the storage apparatus during the given sampling time period, and
the at least one processor calculates the first weighting factor and the second weighting factor on a basis of the dispersion of the first relative positions and the dispersion of the second relative positions.

4. The positioning system according to claim 2,
wherein the at least one processor calculates a travel distance of the apparatus to be positioned on a basis of the acceleration rate output from the first acceleration sensor,
the at least one processor corrects the first relative position on a basis of the calculated travel distance of the apparatus to be positioned, and
the at least one processor calculates a relative position of the apparatus to be positioned with respect to the positioning apparatus on a basis of the corrected first relative position and the second relative position.

5. The positioning system according to claim 4,
wherein the at least one processor calculates a relative position of the apparatus to be positioned with respect to the positioning apparatus on a basis of the first relative position and the calculated travel distance of the apparatus to be positioned, and stores the calculated relative position into the storage apparatus,
the at least one processor calculates, on a basis of the plurality of the first relative positions stored into the storage apparatus during the given sampling time period and a relative position of the apparatus to be positioned based on a plurality of the travel distances, a third weighting factor regarding the first relative position and a fourth weighting factor regarding the relative position of the apparatus to be positioned based on the travel distance, and
the at least one processor corrects the first relative position on a basis of the first relative position, the third weighting factor, the relative position of the apparatus to be positioned based on the travel distance, and the fourth weighting factor.

6. A positioning method comprising:
calculating, on a basis of wireless communication between a positioning apparatus and an apparatus to be positioned separated from the positioning apparatus, a first relative position as a relative position of the apparatus to be positioned with respect to the positioning apparatus;
calculating, on a basis of wireless communication between the positioning apparatus and an auxiliary apparatus separated from the positioning apparatus and from the apparatus to be positioned, a relative position of the auxiliary apparatus with respect to the positioning apparatus;
calculating a relative travel distance of the apparatus to be positioned with respect to the auxiliary apparatus on a basis of an acceleration rate output from a first acceleration sensor included in the apparatus to be positioned and an acceleration rate output from a second acceleration sensor included in the auxiliary apparatus;
calculating a relative position of the apparatus to be positioned with respect to the auxiliary apparatus on a basis of the first relative position, the calculated relative position of the auxiliary apparatus with respect to the positioning apparatus, and the relative travel distance;
calculating a second relative position as a relative position of the apparatus to be positioned with respect to the positioning apparatus on a basis of the calculated relative position of the auxiliary apparatus with respect to the positioning apparatus and the calculated relative position of the apparatus to be positioned with respect to the auxiliary apparatus; and
calculating a relative position of the apparatus to be positioned with respect to the positioning apparatus on a basis of the first relative position and the second relative position.
